(19) United States
(12) Patent Application Publication
(10) Pub. No.: US 2008/0264372 A1
(43) Pub. Date: Oct. 30, 2008

(54) Two-stage ignition system

(76) Inventors: David B. Sisk, Brownsboro, AL (US); Greg Z. Saks, Madison, AL (US)

Correspondence Address: Giaccherini, Post Office Box 1146, Carmel Valley, CA, 93924, US

(21) Appl. No.: 12/077,531

(22) Filed: Mar. 17, 2008

Related U.S. Application Data
(60) Provisional application No. 60/907,084, filed on Mar. 19, 2007.

(51) Int. Cl. F02P 21/00; F02P 7/00

(52) U.S. Cl. 123/144; 123/146.5 R; 60/257

(57) ABSTRACT

Methods and apparatus for providing a Two-Stage Ignition System are disclosed. In one embodiment of the invention, a pilot stage (16) is employed to ignite a plurality of propellants (12, 14) and to create a pilot flame (22). The plurality of propellants (12, 14) are ignited in the main combustion stage (24) using the pilot flame (22), and a flow of an elevated temperature combustion product (30) is produced.

### CROSS-REFERENCE TO A RELATED PROVISIONAL PATENT APPLICATION & CLAIM FOR PRIORITY

The Present Non-Provisional patent application is related to Pending Provisional Patent Application Ser. No. 60/907,084, filed on 19 Mar. 2007, entitled Catalytic Combustion Device for Space Vehicle Applications. The Applicants hereby claim the benefit of priority under 35 U.S.C. Sections 119 or 120 for any subject matter which is commonly disclosed in the Present Non-Provisional patent application and Pending Provisional Patent Application Ser. No. 60/907,084.

### FEDERALLY SPONSORED RESEARCH OR DEVELOPMENT

The Applicants developed some of the Inventions described in the Present Non-Provisional Patent Application under a Contract with NASA Glenn Research Center, Contract No. NNC06CB27C.

### FIELD OF THE INVENTION

The present invention pertains to methods and apparatus for igniting a gas flow. More particularly, one preferred embodiment of the invention comprises a two-stage ignition method for creating a flow of elevated temperature combustion product using bipropellants. The present invention includes a number of methods for ignition and re-ignition of propellants for a broad range of ground and flight applications including rocket engines, reaction control system thrusters, rocket turbomachinery gas generators, propellant conditioning systems and pressurization heaters.

### BACKGROUND OF THE INVENTION

The current art of ignition methods for creating a flow of elevated temperature combustion product using bipropellants (oxidizer and a fuel) all employ a single “stage.” The term “stage” refers to a series of uninterrupted, sequential events, including introducing propellants into a chamber or area and igniting the mixture, and in some cases, including propagating the combustion product through various means to ignite other propellants to produce an ignition combustion product such as a torch. Conventional single stage ignition methods create a final combustion product using bipropellants in a relatively short period of time through a series of precise, time-synchronized events such as opening propellant valves, allowing the flows to pre-mix in a chamber, and then introducing a spark to this mixture at a certain specific time lag from the initial valve openings. Interrupting this series of precise, time-synchronized events with a significant time lag generally leads to failure of the method to produce its final elevated temperature combustion product.

An ignition system is required for liquid bipropellant rocket engines that do not use hypergolic propellants (hypergolic propellants ignite spontaneously upon contact with each other). Proper engine combustion chamber ignition for liquid bipropellant rockets is crucial to the success of a space launch mission. Failed ignition in flight can leave a payload in a useless orbit or even cause a catastrophic loss of the payload. Rocket engine ignition (and re-ignition for restartable engines) has historically been a significant source of unreliability for space launch vehicles, and the main cause of a number of mission failures. Among others, in-flight Ariane rocket mission failures occurred due to third stage HM-7B rocket engine ignition failure on 12 Sep. 1985 for an Ariane 3 and on 31 May 1986 for an Ariane 2.1 Similarly, two launches of Japan's LS-4 rocket in the mid-1960s, and a series of launches of the Russian LV Molniya launch vehicle in the 1960s all failed due to upper stage engine ignition failures. Engine ignition failure has also been blamed for costly launch vehicle aborts on the launch pad such as for a 28 Jan. 1999 Delta II launch attempt which was aborted due to first stage vernier engine ignition failure. Failed ignition on the launch pad can also possibly result in unburned engine fuel and oxidizer expelled from the rocket engine onto the launch pad which could, in-turn, cause an explosion.

Most modern liquid bipropellant rocket engines used for space launch employ either a spark-torch igniter (e.g. the Space Shuttle Main Engine, RL-10, and J-2) or a pyrophoric (hypergolic) igniter (e.g. RD-180, F-1). Pyrotechnic and pyrogen igniters contain explosive materials and are commonly used in solid rocket motors but not in liquid bipropellant rocket engines.

The start-up of rocket engines, including initiation of combustion, is a complex, dynamic process that challenges rocket engine designers due to the possible presence of combustion instabilities and vibrations that can cause operational inefficiencies, structural damage, or even catastrophic engine failure. Combustion instabilities derive from specific combinations of rocket combustion chamber, injector, igniter, and propellant feed geometries and operational dynamic interactions. One such instability is a hard start, caused when too much propellant enters the combustion chamber prior to ignition and the resultant rate of build-up of combusted gasses results in an excessive pressure spike. Another instability example is combustion vibration sometimes caused when combustion chamber pressure rises too slowly due to a temporary too low injector pressure drop during thrust build-up. Rocket engines thus typically have very exact start-up timing sequencing—often to within milliseconds—to ensure the occurrence and magnitude of such instabilities are minimized. Further, propellant flows that are too strong can quench the ignition spark or flame. In current art rocket ignition systems, the ignition method is a critical part of this sequencing.

Spark-torch igniters typically burn a bipropellant mixture obtained from the main engine feeds although some utilize a separate propellant supply. Spark-torch igniter systems require significant development and integration into the overall engine system to ensure ignition occurs at the precise time synchronized with other engine processes such as propellant flow into the combustion chamber. Timing errors as short as a few tens of milliseconds can potentially cause hard starts or even engine failures. Spark-torch igniter systems also require high voltage electrical components which may need special handling and shielding, especially in a vacuum or space environment. The performance of some spark-torch igniter systems is sensitive to oxidizer-to-fuel mixture ratio, flow rates, excitation voltage, and spark rate, making the system relatively complex.

Catalytic-torch igniters have been studied extensively and successfully applied to ground systems but have had only limited application to date on rockets.

Combustion wave ignition systems are sometimes used in large segmented or compartmentalized rocket engines that require propellant ignition in several combustion chambers at the same time. Such systems use a spark igniter to combust premixed propellants in a specially designed chamber that creates a combustion wave which propagates very rapidly through connected, propellant-filled manifolds to reach all of the combustion chambers or possibly individual torches for each combustion chamber. Combustion wave igniters use a single stage ignition method in that the final combustion product—a flame to enter a rocket combustion chamber—is produced by a single series of uninterrupted, sequential events, propagating from the initial combustion.

Pyrophoric or hypergolic igniters inject a chemical into a rocket engine's combustion chamber along with the propellants. The chemical, often triethylaluminium (EADS 300N cryogenic rocket engine) or a mixture of triethylborane and triethylaluminium (e.g., F-1), ignites spontaneously with the oxidizer and burns at a very high temperature. These chemicals are highly corrosive, toxic, and ignite spontaneously on contact with air, and are thus expensive and risky to use.

Until now, all ignition systems used to ignite liquid bipropellant rocket engines have used a single stage. Such systems create a flow of elevated temperature combustion product by a single ignition event, such as a spark-induced, catalytic-induced, or compression wave-produced ignition of propellants, or a series of dependent, time-synchronized events, such as igniting a mixture that propagates directly to light one or more torches that feed into rocket engine combustion chambers. Single stage ignition methods generally employ relatively high propellant mass flow rates (usually 0.1 to 1.0% of the main engine's propellant total flow rate) to ensure proper rocket engine combustion chamber ignition. These relatively high flow rates generally result in high temperature igniter flows which, combined with the proximity of many embodied detection devices to the very hot rocket engine combustion chamber, tend to reduce lifetime and reliability of devices used to detect successful igniter operation.

To date, rocket engine reusability has been minimal beyond that of a few restarts in a single mission. However, USAF and NASA have invested heavily in research and development of reusable or partially reusable launch vehicles. Such vehicles will require rocket engine ignition systems with improved reusability, reliability, and longer operational life.

As implied above, detection of successful operation of the igniter before committing high pressure main rocket engine propellants to the combustion chamber is important. In an attempt to lower the risk of ignition system failure, safety interlocks are sometimes used to override main propellant valves if the ignition source is not operating properly. However, the reliability of the safety interlocks has been less than ideal and accurate, reliable detection of proper ignition system operation is challenging. One detection procedure is to use thin wires stretched over the path of the ignition torch or engine nozzle which provide a positive ignition operation signal when the wires are burned through. However, this method can be compromised by wire breakage caused by wind or incomplete burn-through of the wires due to improper placement. Pressure sensors, thermocouple sensors, and cameras to detect electromagnetic spectra such as infrared are also sometimes used, but these methods have not been generally highly reliable due to the very challenging environment (very high acoustic, acceleration, and thermal loads) in the vicinity of a rocket's engine. Further, rocket engine ignition systems are generally uniquely designed, developed, and fabricated to their particular application and thus generally very unique and are not reused among various rocket subsystems, even though they share common functional needs (e.g., rocket engine ignition, reaction control system ignition, propellant conditioning system ignition, etc.) Due to this uniqueness and very small economies of scale, rocket engine ignition systems have high non-recurring development and recurring hardware costs.

Conventional single stage ignition devices are limited by their single stage design. The development of an ignition system for bipropellant applications with improved reliability, longer operational life, greater operational flexibility, lower cost through design simplicity, and reduced complexity would constitute a major technological advance, and would satisfy long felt needs and aspirations in the aerospace industry.

### SUMMARY OF THE INVENTION

The invention comprises methods and apparatus for a two-stage ignition method for creating a flow of elevated temperature combustion product using bipropellants. While this elevated temperature combustion product may be used for a broad range of ground and flight applications, rocket systems form a set of important applications. The final combustion product can be integrated into and used for rocket engine ignition, for rocket turbomachinery, propellant conditioning, or pressurization systems, or expanded through a nozzle to provide thrust for a small rocket, as for a reaction control system.

In one embodiment, the invention comprises a two-stage ignition method for creating a flow of elevated temperature combustion product. Instead of only a single stage employing a relatively high propellant mass flow rate as with the conventional ignition system, the present invention adds a preliminary stage, or “pilot stage,” which employs a relatively low propellant mass flow rate. The pilot stage produces a combustion product through ignition of bipropellants, that is then used to ignite propellants in the main combustion stage. The pilot stage can be operated alone, independent of the main combustion stage. The main combustion stage can be switched on and off, or pulsed, depending upon need.

The relatively benign heating environment of this pilot stage compared to the main combustion stage (and thus current art torch igniter systems) reduces stress on the igniter improving overall ignition system reliability and increasing operational life. This seclusion of the igniter to the pilot stage likewise allows for the elevated temperature combustion product resulting from the main combustion stage to use higher propellant flows and have higher temperatures than most current art systems. This serves to allow the elevated temperature combustion product to be used for a variety of applications for which a current art ignition system would be inadequate.

The present invention enables the same design to be used for multiple uses in different rocket systems or subsystems that need a flow of elevated temperature combustion product, lowering non-recurring development costs, increasing production economies of scale and thus lowering recurring hardware acquisition costs. These different rocket systems include, but are not limited to, main rocket engine torch ignition, propellant conditioning heaters, turbomachinery preburners, and small rocket engines, such as reaction control system thrusters.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 presents a flow chart which illustrates a first embodiment of the present invention.

FIG. 2 presents a flow chart which illustrates a second embodiment of the present invention.

FIG. 3 is a side cut-away view of one of the embodiments of the present invention.

FIG. 4 is a partial cut-away view of one of the embodiments of the present invention.

FIG. 5 is a flow chart which depicts a generalized method of the invention.

FIGS. 6, 7 and 8 are schematic views that portray exemplary methods of the invention.

FIGS. 9, 10, 11, 12, 13 and 14 exhibit applications of the invention to rockets, missiles, a rocket gas generator, and a landing module.

### A DETAILED DESCRIPTION OF PREFERRED & ALTERNATIVE EMBODIMENTS

### I. Overview of the Invention

One embodiment of the present invention comprises a two-stage ignition method for creating a flow of elevated temperature combustion product using bipropellants. In one particular embodiment, the invention utilizes two different ignition stages, a “pilot stage,” which ignites relatively low mass flow rates of bipropellants to create a pilot flame, and a “main combustion stage,” which utilizes the pilot flame to ignite relatively high mass flow rates of bipropellants to produce a flow of elevated temperature combustion product.

### II. Preferred & Alternative Embodiments of the Invention

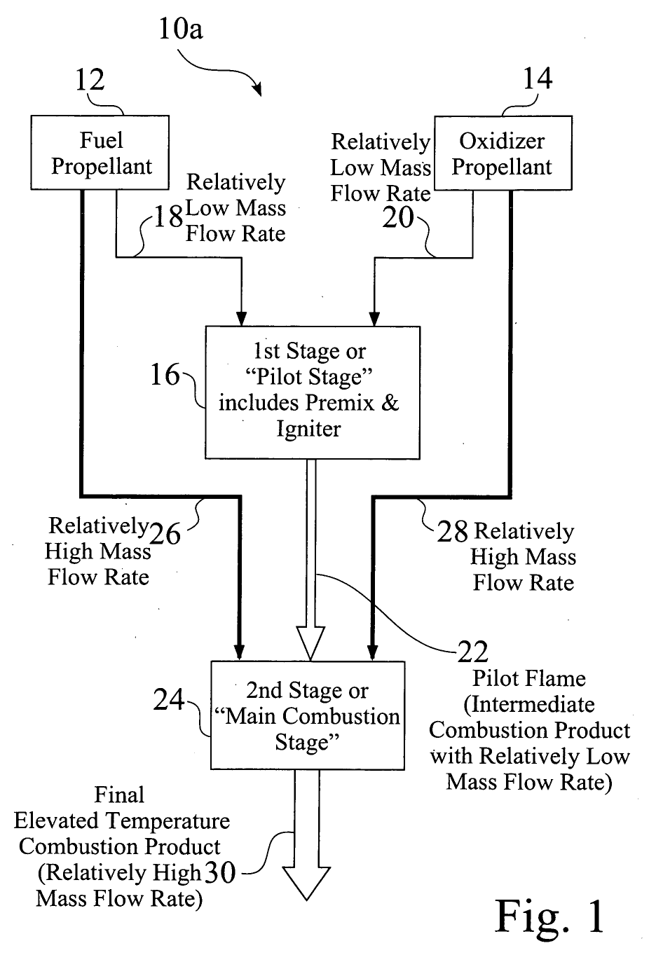

FIG. 1 is a flow chart which illustrates one particular embodiment 10a of the invention. A fuel propellant 12 and an oxidizer propellant 14 are introduced into a first or pilot stage 16, where the propellants are pre-mixed. The pilot stage 16 includes an igniter. Both the fuel propellant 12 and the oxidizer propellant 14 are introduced into the pilot stage 16 at a relatively low mass flow rate 18 & 20. These two flows may be controlled separately, and the propellants may be in either liquid or gas form. These flows are controlled by suitable valves and control devices that are well-known in the art. In this Specification and in the Claims that follow, the terms “bipropellant” and “propellant” include any fuel, oxidizer or other substance in any physical phase (solid, liquid, gas, plasma) which may be suitable for use with the present invention. In this Specification, and in the Claims that follow, the term “relatively high mass flow rate” indicates a mass flow rate that is at least one order of magnitude greater than a “relatively low mass flow rate.” The pilot stage 16 produces a pilot flame 22, which comprises an intermediate combustion product with a relatively low mass flow rate.

The embodiment 10a shown in FIG. 1 also includes a second or main combustion stage 24. The fuel propellant 12 and the oxidizer propellant 14 are introduced into the main combustion stage 24 at relatively high mass flow rates 26 & 28. These two flows may be controlled separately, and the propellants may be in either liquid or gas form. The propellants in the main combustion stage 24 are ignited by the pilot flame 22. The main combustion stage 24 produces a final, elevated temperature combustion product 30 with a relatively high mass flow rate.

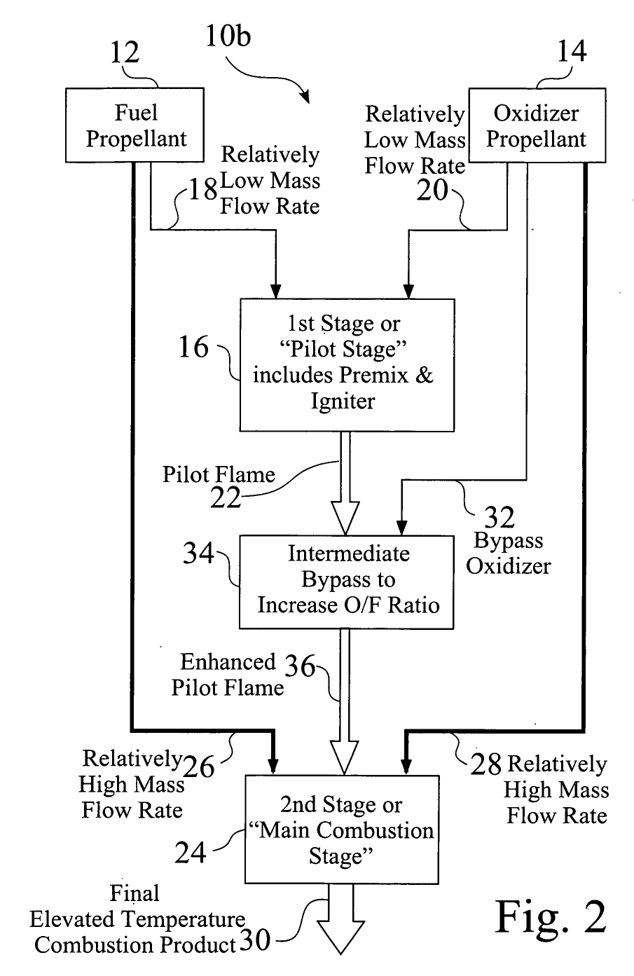

FIG. 2 is another flow chart which illustrates another particular embodiment 10b of the invention. In the embodiment shown in FIG. 2, a bypass oxidizer 32 is introduced into an intermediate bypass 34 to increase the oxidizer/fuel ratio. The intermediate bypass 34 produces an enhanced pilot flame 36, which ignites the propellants in the main combustion stage 24.

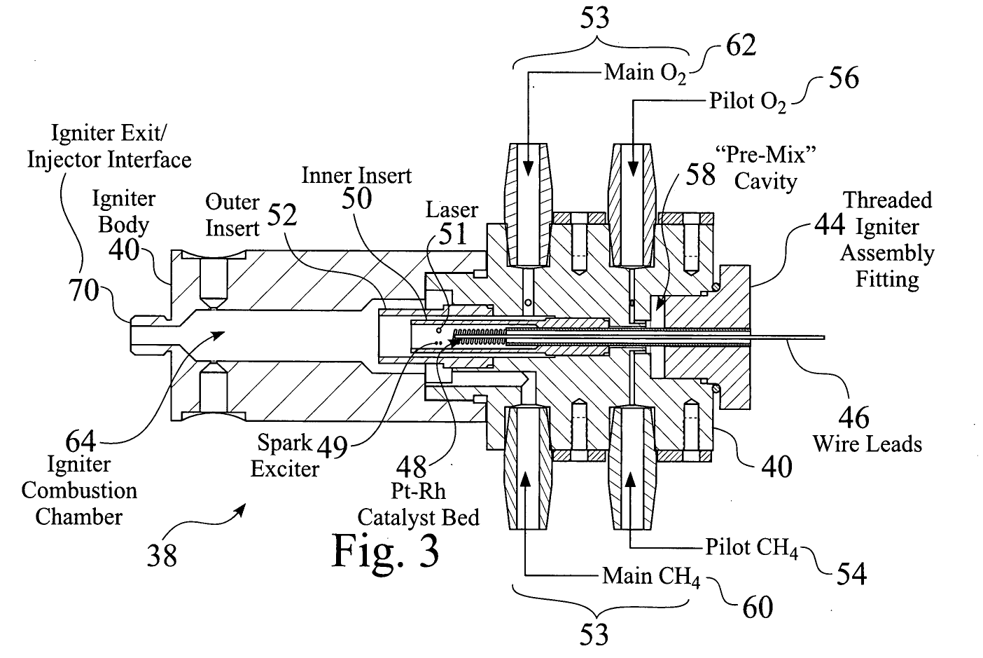

FIG. 3 is a side cut-away view of one of the particular embodiments 38 of the present invention. The embodiment shown in FIG. 3 comprises an igniter body 40 which includes a threaded igniter assembly fitting 44 disposed at one end of the igniter body 40. Wire leads 46 or some other suitable electrically conductive device extend into and protrude out of the igniter body 40, and terminate within the body 40 in the general area of a catalyst bed 48. The flow of electrical current which initiates a spark is controlled by switches and circuitry which are well-known in the art. In this particular embodiment, the catalyst bed 40 includes a mixture of platinum (Pt) and rhodium (Rh). This catalyst bed 40 encourages ignition, and other suitable combinations of substances may be used in alternative embodiments of the invention. The catalyst bed 48 is generally a metal sleeve, wire, or mesh, and is surrounded or enclosed by an inner insert 50 and an outer insert 52.

In the embodiment shown in FIG. 3, four generally cylindrical ports 53 are built into the sides of the igniter body 40. Two of these ports 53 are located on opposite sides of the igniter body 40, and are aligned in a direction which is generally orthogonal to the longitudinal axis of the igniter body 40, which runs along its center and is generally colinear with the wire leads 46, inner insert 50 and outer insert 52. In different embodiments and implementations of the invention, these ports 53 may be used to introduce or supply different propellants or other materials or substances to the interior of the igniter body. Persons possessing ordinary skill in the art to which this invention pertains will appreciate that these ports could be used to introduce a non-combustible purge gas into one or more of these ports 53 to render inert the ignition system 38. Similarly, the introduction of a non-combustible purge gas could be used to render shut down a device integrated with the present invention, such as a rocket engine. In FIG. 3, flows of propellants through these four ports 53 are indicated by arrows with filled-in triangular heads.

In FIG. 3, the first two of the four ports 53 are used to supply pilot methane (CH₄) 54, a fuel, and pilot oxygen (O₂) 56, an oxidizer. Other suitable fuel and oxidizer gas or liquid propellants may be utilized. The flows of methane 54 and oxygen 56 are fed to a pre-mix cavity 58. The mixed flows of gas then proceed from the pre-mix cavity 58 toward the center of the igniter body 40 to the region surrounded by the inner insert 50. The pilot flame 22 is created by catalytic ignition of the mixed propellant flow as it passes over the catalyst bed 48, which is preheated by electricity propagated across the wire leads 46. FIG. 3 also depicts the general location where an optional spark exciter 49 or laser 51 may be employed to provide ignition.

Main streams of methane and oxygen 60 & 62 are introduced into the third and fourth ports 53, and flow into the igniter combustion chamber 64. These streams are ignited by the pilot flame 22. The main streams of methane and oxygen 60 & 62 are supplied at relatively high mass flow rates compared to the relatively low mass flow rates 18 & 20 which feed the pilot stage 16. A final elevated temperature combustion product 30 is formed within the igniter combustion chamber 64, and propagates out of the igniter at the terminal end of the igniter body 40 through an igniter exit/injector interface 70, which may also function as a generalized nozzle.

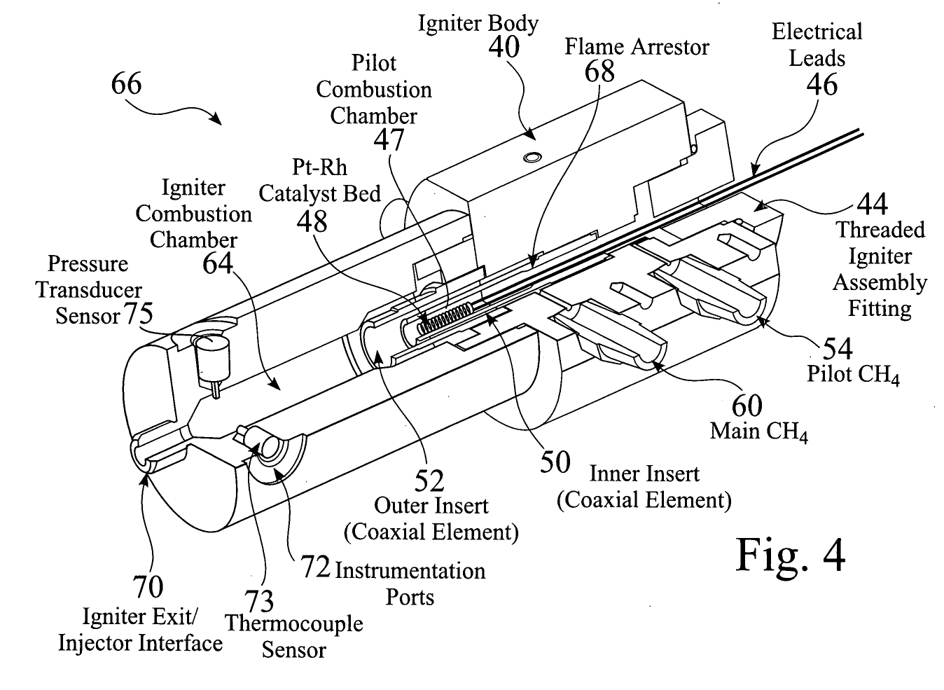

FIG. 4 is a partial cut-away view of one of the specific embodiments 66 of the present invention. A pilot combustion chamber 47 is shown in the general vicinity of the catalyst bed 48. This view reveals the location of a flame arrestor 68 and instrumentation ports 72. The instrumentation ports 72 may be fitted with a variety of sensors, including a thermocouple sensor 73 or a pressure transducer sensor 75. Persons possessing ordinary skill in the art to which this invention pertains will appreciate that the flame arrestor 68 serves to inhibit flame propagation into the pre-mix cavity 58.

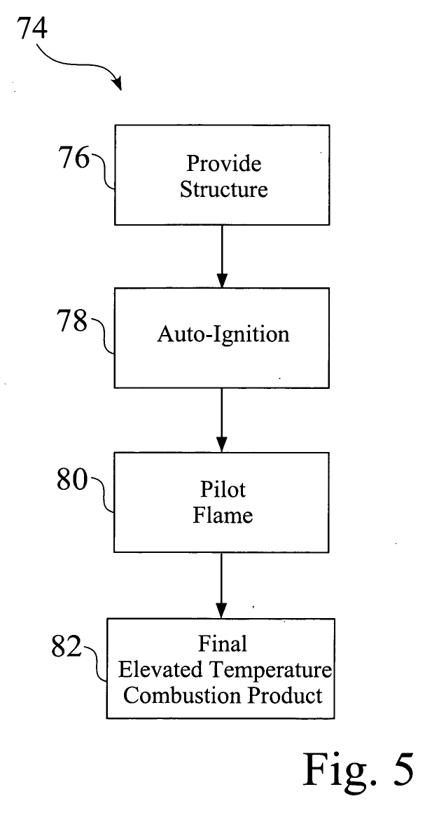

FIG. 5 offers a flow chart which illustrates one of the generalized methods 74 of the invention. In the first general step 76, a suitable structure, which generally includes a first and second stage, is provided. In the second general step 78, relatively low mass flows of fuel propellant and oxidizer propellant are ignited to create a pilot frame by a catalytic chemical reaction of the propellants with a warm catalyst bed. In the third general step 80, a pilot flame is introduced into a second or main stage, where relatively high mass flows of fuel and oxidizer propellants are ignited to form a final, elevated temperature combustion product 82.

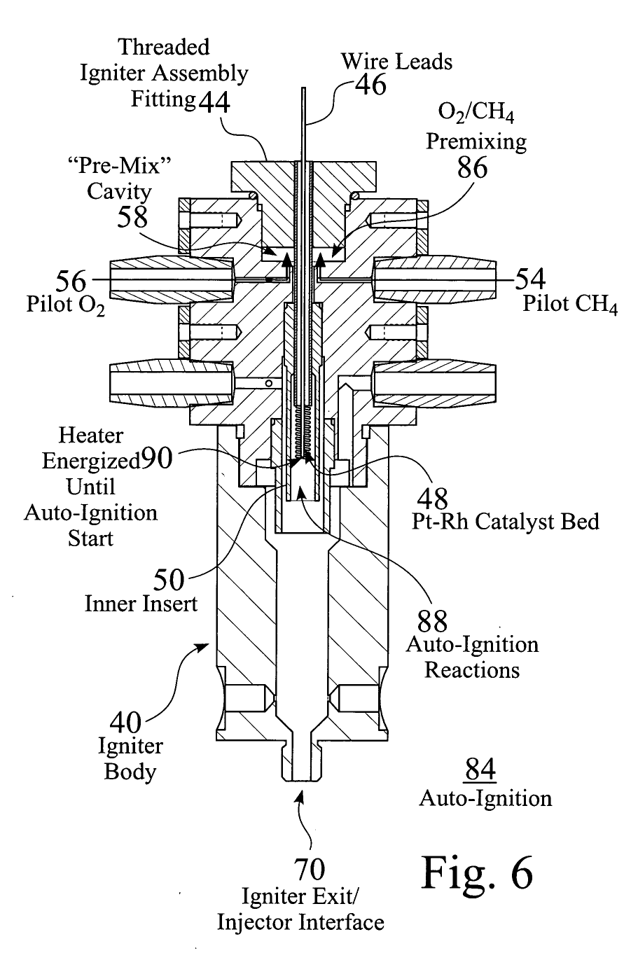

FIGS. 6, 7 and 8 are schematic views that portray exemplary methods of the invention. All of these three figures show the premixing of oxygen and methane 86 in a pre-mix cavity 58.

In FIG. 6, the auto-ignition step 84 is depicted. Pilot methane 54 and pilot oxygen 56 are supplied in the two ports 53 which are nearest to the end of the igniter body 40 which has the wire leads 46 extending from it. The other two ports, which are closer to the end of the igniter body 40 which includes the igniter ext/injector interface 70, are not used in step 84 in the specific embodiment shown in FIG. 6. In FIGS. 6, 7 and 8, the flows of gas through the ports 53 is indicated by lines that extend into the ports and that terminate in solid arrowheads. FIG. 6 also furnishes a view of the location of auto-ignition reactions 88 within the inner insert 50, and the use of a catalyst bed heater 90, which is energized until auto-ignition start.

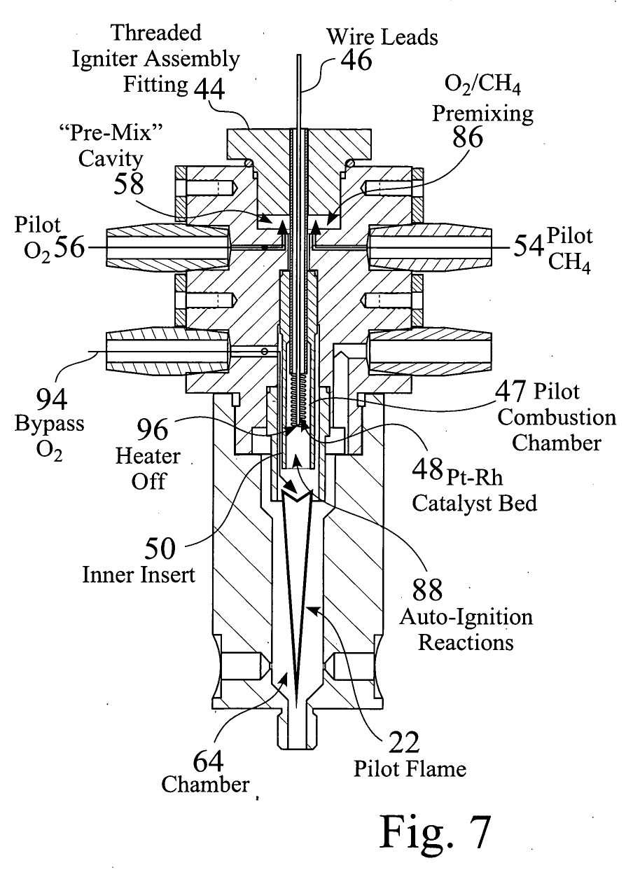

FIG. 7 reveals the next step in the general method of the invention. A bypass flow of oxygen 94 is admitted into the third port 53, while the heater is turned off 96. Auto-ignition reactions 88 occur in the region enclosed by the inner insert 50, and a pilot flame 22 is produced within the combustion chamber 64.

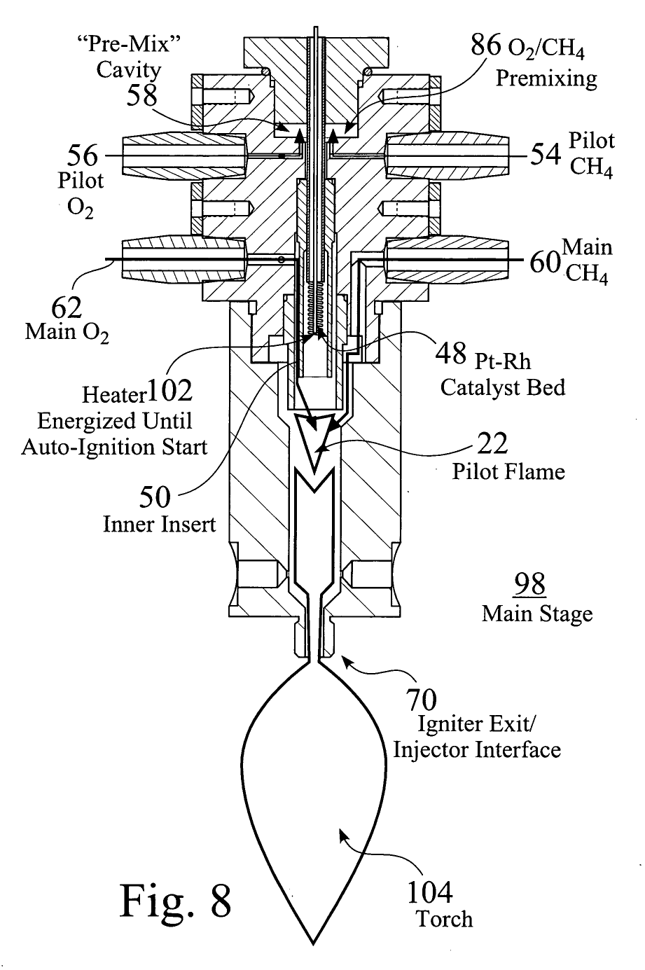

Finally, in FIG. 8, all four ports 53 are active, and introduce gases into the igniter body 40. In this final main stage step 98, pilot oxygen 56 and pilot methane 54 stream into the upper two ports, while flows of main oxygen 62 and main methane 60 travel into the lower two ports 53. The higher mass flow rates of main oxygen 62 and main methane 60 are indicated with the heavier lines, compared to the lighter flow lines shown for the main oxygen 62 and pilot methane 54. The resulting final elevated temperature combustion product in this implementation is the torch 104, which is shown propagating through igniter exit/injector interface 70.

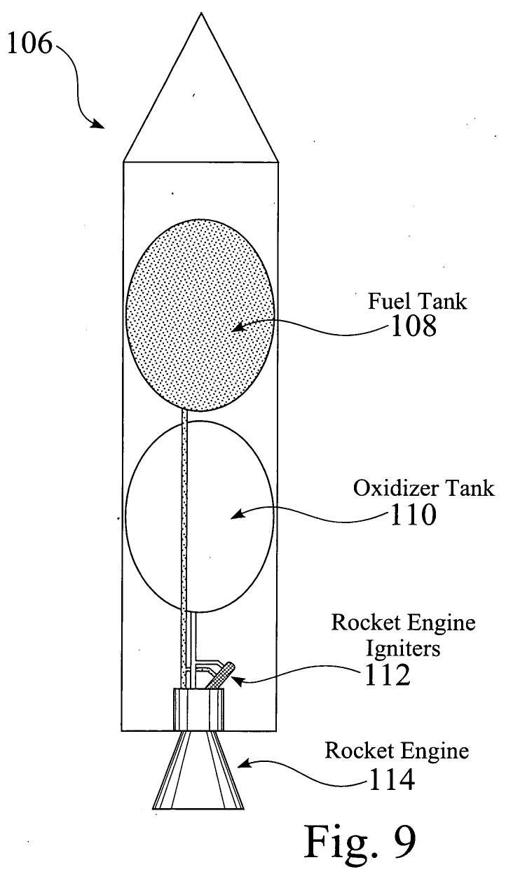

FIGS. 9, 10, 11, 12, 13 and 14 exhibit applications of the invention to rockets, missiles, and a landing module.

FIG. 9 depicts the application of the ignition method invention in a rocket or missile 106 in which it is used to ignite rocket engines, and both igniters and rocket engines use the same fuel and oxidizer propellants.

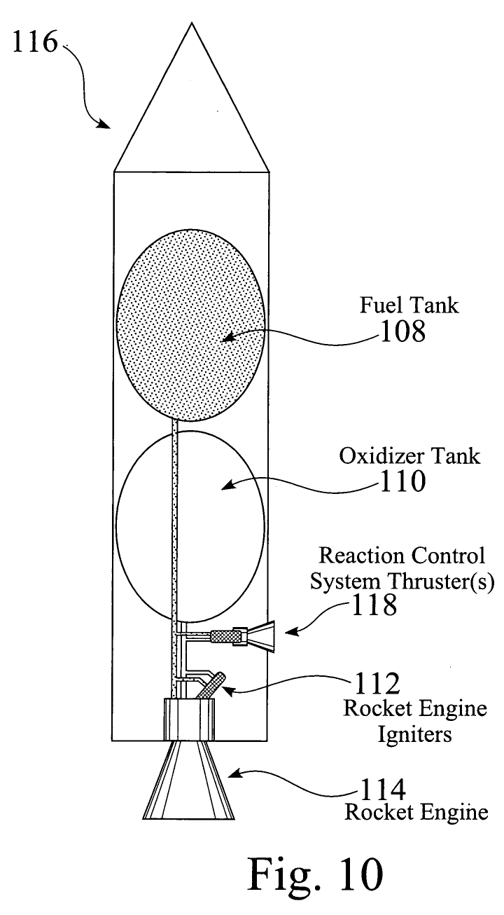

FIG. 10 depicts the application of the ignition method invention in a rocket or missile 116 in which it is used to ignite rocket engines and to generate reaction control system thrust, all using the same fuel and oxidizer propellants.

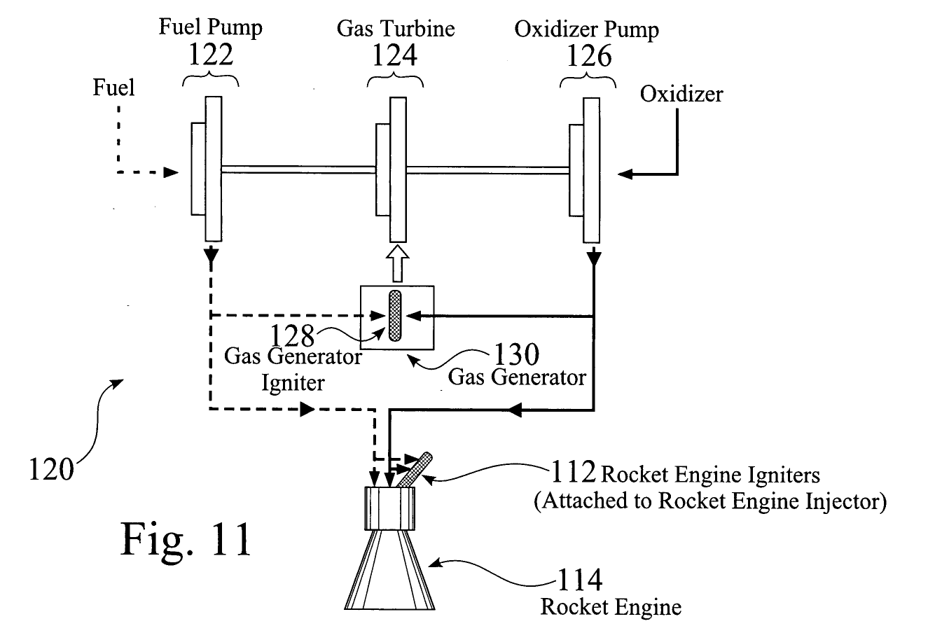

FIG. 11 depicts the application of the ignition method in a rocket or missile 120 employing a gas generator cycle in which the invention is used to ignite the rocket engine and to ignite a gas generator to power rocket engine fuel and oxidizer turbopumps.

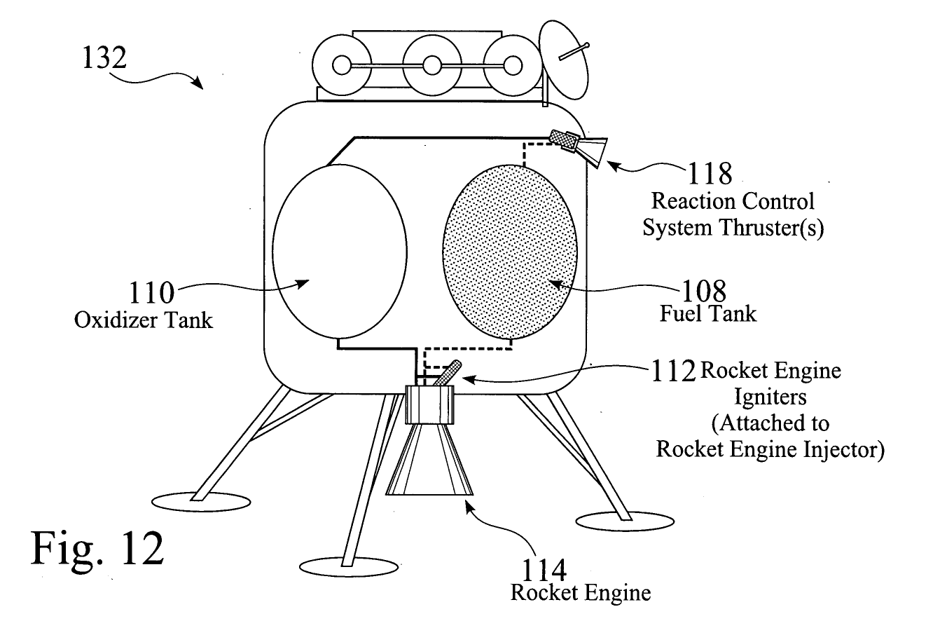

FIG. 12 depicts the application of the ignition method to ignite rocket engines and to generate reaction control system thrust for a landing module 132, all using the same fuel and oxidizer propellants.

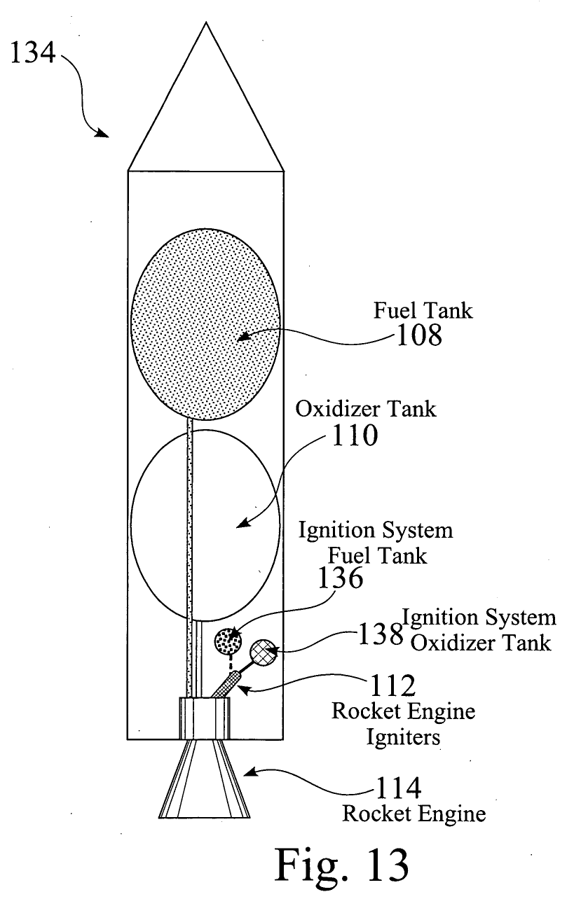

FIG. 13 reveals the application of one embodiment of the ignition method invention in a rocket or missile 134, in which the present invention is used to ignite rocket engines. In this application, the igniters and the rocket engines use different fuel and oxidizer propellants.

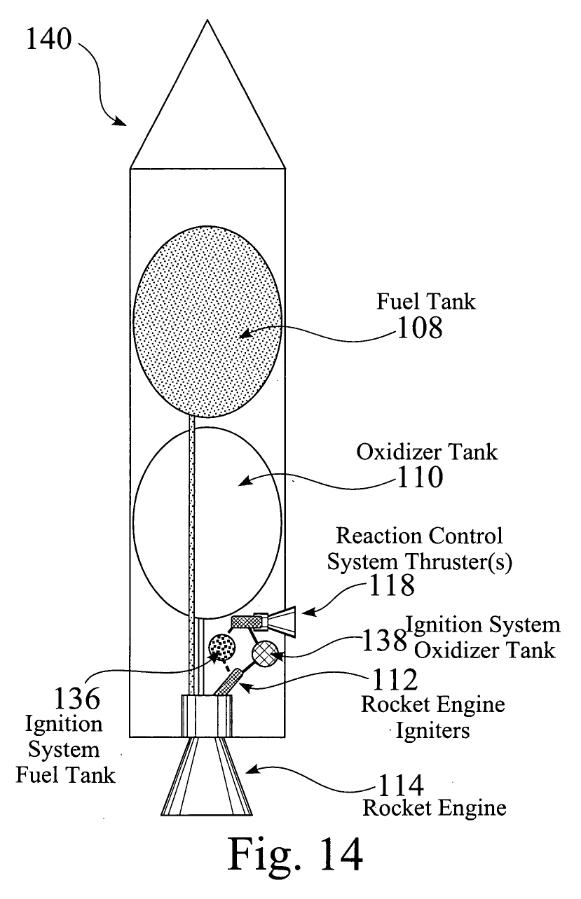

FIG. 14 reveals the application of one embodiment of the ignition method invention in a rocket or missile 140, in which the present invention is used to ignite rocket engines and to generate reaction control system thrust. In this application, the rocket engine ignition system and the reaction control system use the same fuel and oxidizer propellants, but different propellants than are used by the rocket engines.

### III. Additional Features, Aspects & Applications of the Invention the Igniter Body

In one embodiment of the invention, the igniter body is manufactured from metal. The metal machining and fabrication processes which may be employed to build the igniter body are generally well known in the art.

### Pilot Stage

The pilot stage consists of a means of introducing separate, controlled, relatively low mass flow rate, flows of oxidizer and fuel into a mixing chamber to produce a controlled oxidizer-to-fuel mixture ratio of propellant which then flows into a pilot combustion chamber containing an ignition source. The propellant is then ignited with an electrically-produced spark, a chemical reaction due to contact with a catalytic reactor, a laser or by other suitable means, producing a relatively small, continuous combustion product called the pilot flame. In some embodiments for certain propellant and ignition source combinations, the mixture is regulated to be fuel-rich (low oxidizer-to-fuel mixture ratio) to reduce temperatures in the pilot stage. The pilot flame propagates from the pilot combustion chamber into a main combustion chamber. In some embodiments using certain propellants, an additional “bypass” flow of oxidizer at a relatively low mass flow rate is introduced either into the pilot combustion chamber or into an intermediate bypass combustion chamber between the pilot combustion chamber and the main combustion chamber, serving to increase the oxidizer-to-fuel mixture ratio and strengthen the pilot flame.

### Main Combustion Stage

The main combustion stage consists of a means of introducing separate, controlled, relatively high mass flow rate, flows of oxidizer and fuel at a controlled oxidizer-to-fuel mixture ratio into the main combustion chamber, whereupon the propellants are ignited by the pilot flame to form a final, combined, relatively large, elevated temperature combustion product which is expelled from the main combustion chamber through an exit orifice. The oxidizer could be cryogenic liquid or gaseous oxygen, or a myriad of other oxidizing propellants. The fuel could be kerosene or kerosene-based rocket fuel, cryogenic liquid or gaseous hydrogen, cryogenic liquid or gaseous methane, or a myriad of other fuel propellants.

For embodiments concerning rocket applications, the propellants may be obtained either directly from the main propellants tanks or from independent tank sources. The ignition source may be an electrical spark exciter, a laser, a catalyst device, or other ignition source. The catalyst device may be a bed, metal sleeve, wire, or mesh composed of or containing a catalyst. Depending on the propellants selected for use in this method, the catalyst device may be pre-heated by any one of a variety of means including electrical resistance heating.

The pilot stage may be used continuously as a pilot light to produce its relatively low flow rate, self-sustaining, high-temperature gas stream suitable for ignition of the propellants introduced into the main chamber, or switched on and off as needed. The main combustion stage may be operated in either a steady state (on or off) or pulsed mode, enabling a single physical embodiment device of this method to serve multiple applications.

The method of the present invention may incorporate one or more thermocouple and/or pressure transducer sensors and associated electrical circuits to directly or indirectly verify the pilot flame and/or final elevated temperature combustion product are operational. The thermocouple and pressure transducer sensors and associated electrical circuits may be used as part of a safety interlock between an embodiment of this method and its application to an external system, such as the case of a safety interlock used to confirm proper rocket engine igniter operation before initiating propellant flows into the rocket engine combustion chamber.

The final combustion product may be used directly or indirectly for many purposes, including, but not limited to, thrust generation (e.g., reaction control system for a rocket, satellite, or spacecraft), heat generation (e.g., to create warmed inert gas as part of a pressurization system), or as a means to initiate combustion in a broader process (e.g., torch igniter for ignition of propellants in a rocket engine main combustion chamber or in a rocket turbopump preburner.)

The exit orifice (and exterior of the apparatus) is generally uniquely fashioned to serve an appropriate function and as an appropriate interface to other fixtures depending upon its particular application. For example, when the elevated temperature combustion product produced by the method is used for thrust generation for a reaction control system, the exit orifice (and exterior of the apparatus) serves as a throat and interface to an attached nozzle.

One embodiment of the method of the present invention is for a single design fulfilling the dual application of a rocket engine torch igniter and rocket reaction control system thruster. This embodiment uses a heterogeneous Group VIII metal catalyst (Platinum, Rhodium, Palladium, etc.) as the ignition source for the pilot stage. In this embodiment of this method, first the catalyst is pre-heated by electrical resistance heating. The relatively low flow rate oxidizer and fuel flows are then individually modulated and pre-mixed in a small mixing chamber using a fuel-rich mixture, after which they flow through a flame arresting screen or device, and then over the hot catalyst bed. A relatively low oxidizer-to-fuel (fuel-rich) mixture ratio is used to keep combustion temperatures within the pilot stage at moderate levels to increase device durability and operational lifetime. The hot catalytic bed activates oxidizer molecular dissociation at the catalyst bed surface and enables a catalytic reaction that automatically promotes self-sustaining combustion. In this embodiment, an oxidizer bypass between the propellant feedlines for the main combustion stage and the pilot stage injects a relative low mass flow rate of bypass oxidizer downstream of the catalyst bed. This additional oxidizer mixes with the hot fuel-rich gases from the catalyst bed and spontaneously ignites to a diffuse pilot flame in the pilot combustion chamber, serving to increase the oxidizer-to-fuel mixture ratio and create a more energetic, diffuse pilot combustion jet which propagates into the main combustion chamber. The catalyst heater is then turned off and relatively high flow rates of additional fuel and oxidizer are injected into the main combustion chamber through the main oxidizer and fuel feedlines and are ignited by the pilot flame. The final, combined, elevated temperature, combustion product is expelled from the main combustion chamber through an exit orifice. For the reaction control system thruster application of this embodiment, the main combustion chamber exit orifice is the throat of the reaction control thruster nozzle and the surface around the orifice is designed to be attached to the reaction control thruster nozzle. For the reaction control system thruster application of this embodiment, the pilot flame is maintained continuously on by maintaining the low mass flow rate propellant flows during the entire flight phase while the high flow rate main combustion stage is switched on and off to produce thrust as needed. For the rocket engine torch igniter application of this embodiment, the main combustion chamber exit orifice is a nozzle interface into the rocket engine's injector, and the elevated temperature combustion product serves as a torch to ignite the rocket engine propellants. For the rocket engine torch igniter application of this embodiment, both the pilot and main combustion stages may remain continuously on during the entire flight phase, and thermocouple and pressure transducer sensors may be used to verify pilot flame is operational before flowing main rocket engine propellants into the rocket engine combustion chamber.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing an Two-Stage Ignition System that have been disclosed above are intended to educate the reader about preferred embodiments of the invention, and are not intended to constrain the limits of the invention or the scope of Claims.

LIST OF REFERENCE CHARACTERS

| 10a | Flowchart depicting one embodiment of the invention |
|---|---|
| 10b | Flowchart depicting second embodiment of the invention |
| 12 | Fuel propellant |
| 14 | Oxidizer propellant |
| 16 | Pilot Stage |
| 18 | Relatively low mass flow rate |
| 20 | Relatively low mass flow rate |
| 22 | Pilot flame |
| 24 | Main combustion stage |
| 26 | Relatively high mass flow rate |
| 28 | Relatively high mass flow rate |
| 30 | Final elevated temperature combustion product |
| 32 | Bypass oxidizer |
| 34 | Intermediate bypass |
| 36 | Enhanced pilot flame |
| 38 | Cross-sectional view of one embodiment of invention |
| 40 | Igniter body |
| 44 | Threaded igniter assembly fitting |
| 46 | Wire leads |
| 47 | Pilot combustion chamber |
| 48 | Pt-Rh catalyst bed |
| 49 | Spark exciter |
| 50 | Inner insert |
| 51 | Laser |
| 52 | Outer insert |
| 53 | Ports |
| 54 | Pilot CH₄ |
| 56 | Pilot O₂ |
| 58 | Pre-mix cavity |
| 60 | Main CH₄ |
| 62 | Main O₂ |
| 64 | Igniter combustion chamber |
| 66 | Perspective view of one embodiment of invention |
| 68 | Flame arrestor |
| 70 | Igniter exit/Injector interface/Nozzle |
| 72 | Instrumentation ports |
| 73 | Thermocouple sensor |
| 74 | Flowchart illustrating one generalized method of the invention |
| 75 | Pressure transducer sensor |
| 76 | Provide suitable structure |
| 78 | Auto-Ignition |
| 80 | Pilot flame |
| 82 | Final elevated temperature combustion product |
| 84 | Auto-ignition |
| 86 | O₂/CH₄ Pre-mixing |
| 88 | Auto-ignition reactions |
| 90 | Heater energized until auto-ignition start |
| 92 | Pilot flame |
| 94 | Bypass O₂ |
| 96 | Heater off |
| 98 | Main stage |
| 104 | Torch |
| 106 | Application of invention in a rocket or missile |
| 108 | Fuel tank |
| 110 | Oxidizer tank |
| 112 | Rocket engine igniters |
| 114 | Rocket engine |
| 116 | Application of invention in a rocket or missile |
| 118 | Reaction control system thrusters |
| 122 | Fuel pump |
| 124 | Gas turbine |
| 126 | Oxidizer pump |
| 128 | Gas generator igniter |
| 130 | Gas generator |
| 132 | Application of invention in a landing module |
| 134 | Application of invention in a rocket or missile |
| 136 | Application of invention in a rocket or missile |
| 140 | Application of invention in a rocket or missile |

What is claimed is:

1. A method comprising the steps of:
providing a pilot stage (16) for igniting a plurality of propellants (12, 14);
creating a pilot flame (22);
providing a main combustion stage (24) for utilizing said pilot flame (22); and
igniting said plurality of propellants (12, 14) in said main combustion stage (24) using said pilot flame (22); and
producing a flow of an elevated temperature combustion product (30).

2. A method as recited in claim 1, in which:
said plurality of propellants (12, 14) are introduced into said pilot stage (16) at a relatively low mass flow rate.

3. A method as recited in claim 1, in which:
said plurality of propellants (12, 14) are introduced into said main combustion stage (24) at a relatively high mass flow rate.

4. A method as recited in claim 1, in which:
one of said plurality of propellants (12, 14) is a fuel (12).

5. A method as recited in claim 4, in which:
said fuel (12) is methane.

6. A method as recited in claim 4, in which:
said fuel (12) is kerosene.

7. A method as recited in claim 4, in which:
said fuel (12) is kerosene-based rocket fuel.

8. A method as recited in claim 4, in which:
said fuel (12) is a cryogenic liquid.

9. A method as recited in claim 4, in which:
said fuel (12) is hydrogen.

10. A method as recited in claim 1, in which:
one of said plurality of propellants (12, 14) is an oxidizer (14).

11. A method as recited in claim 10, in which:
said oxidizer (14) is a cryogenic liquid.

12. A method as recited in claim 10, in which:
said oxidizer (14) is oxygen.

13. A method as recited in claim 1, further comprising the step of:
pre-mixing said plurality of propellants (12, 14) prior to ignition.

14. A method as recited in claim 1, further comprising the step of:
igniting said plurality of propellants (12, 14) using an ignition source.

15. A method as recited in claim 14, in which:
ignition source is provided by an electrical discharge.

16. A method as recited in claim 14, in which:
ignition source is a spark exciter (49).

17. A method as recited in claim 14, in which:
ignition source is a laser (51).

18. A method as recited in claim 14, in which:
said fuel (12) and said oxidizer (14) are mixed to be fuel-rich to reduce the temperatures in said pilot stage (16).

19. A method as recited in claim 1, further comprising the step of:
igniting said plurality of propellants (12, 14) using a catalyst (48).

20. A method as recited in claim 19, in which:
said catalyst (48) is formed in a bed.

21. A method as recited in claim 19, in which:
said catalyst (48) is formed as a sleeve.

22. A method as recited in claim 19, in which:
said catalyst (48) is formed as a wire.

23. A method as recited in claim 19, in which:
said catalyst (48) is formed as a mesh.

24. A method as recited in claim 19, in which:
said catalyst (48) is pre-heated.

25. A method as recited in claim 19, in which:
said catalyst (48) contains a heterogeneous Group VIII metal catalyst.

26. A method as recited in claim 19, in which:
said catalyst (48) includes platinum.

27. A method as recited in claim 19, in which:
said catalyst (48) includes rhodium.

28. A method as recited in claim 19, in which:
said catalyst (48) includes palladium.

29. A method as recited in claim 1, in which:
said pilot stage (16) is used continuously as a pilot light.

30. A method as recited in claim 1, in which:
introducing an additional bypass flow of said oxidizer (14) at a relatively low mass flow rate into said pilot combustion chamber (47).

31. A method as recited in claim 1, in which:
said main combustion stage (24) is operated in a steady state.

32. A method as recited in claim 1, in which:
said main combustion stage (24) is used in a pulsed mode.

33. A method as recited in claim 1, further comprising the step of:
providing a thermocouple sensor (73) to verify the propagation of said pilot flame (22).

34. A method as recited in claim 1, further comprising the step of:
providing a thermocouple sensor (73) to verify the propagation of said elevated temperature combustion product (30).

35. A method as recited in claim 1, further comprising the step of:
providing a pressure transducer sensor (75) to verify the propagation of said pilot flame (22).

36. A method as recited in claim 1, further comprising the step of:
providing a pressure transducer sensor (75) to verify the propagation of said elevated temperature combustion product (30).

37. A method as recited in claim 1, in which:
said elevated temperature combustion product (30) is used for thrust generation.

38. A method as recited in claim 1, in which:
said elevated temperature combustion product (30) is used for heat generation.

39. A method as recited in claim 1, in which:
said elevated temperature combustion product (30) is used to initiate combustion.

40. A method as recited in claim 1, in which:
said elevated temperature combustion product (30) for operating both as a rocket engine torch igniter and a rocket reaction control system thruster.

41. A method as recited in claim 1, in which:
said pilot flame (22) propagates from said pilot combustion chamber (47) into a main combustion chamber (64).

42. A method as recited in claim 1, in which:
one of said plurality of propellants (12, 14) may be obtained directly from a main propellant tank (108, 110).

43. A method as recited in claim 1, in which:
one of said plurality of propellants (12, 14) may be obtained directly from an independent tank source (136, 138).

44. A method comprising the steps of:
introducing separate, controlled, relatively low mass flow rate, flows of an oxidizer (14) and a fuel (12) into a mixing chamber;
producing a controlled oxidizer-to-fuel mixture ratio of said oxidizer (14) and said fuel (12);
introducing said controlled oxidizer-to-fuel mixture ratio of said oxidizer (14) and said fuel (12) into a pilot combustion chamber (47); said pilot combustion chamber (47) including an ignition source;
activating said ignition source to ignite said controlled oxidizer-to-fuel mixture ratio of said oxidizer (14) and said fuel (12);
introducing separate, controlled, relatively high mass flow rate, flows of said oxidizer (14) and fuel (12) at a controlled oxidizer-to-fuel mixture ratio into a main combustion chamber (64); said main combustion chamber (64) having an exit orifice (70);
igniting said controlled oxidizer-to-fuel mixture ratio of said oxidizer (14) and said fuel (12) in said main combustion chamber (64);
forming a final, combined, relatively large, elevated temperature combustion product (30); and
expelling said final, combined, relatively large, elevated temperature combustion product (30) from said main combustion chamber (64) through said exit orifice (70).

45. An apparatus comprising:
an igniter body means (40) for generating a torch (104);
said igniter body means (40) including a pilot stage means (16) for producing a pilot flame (22);
said pilot flame (22) being produced by mixing and igniting a fuel (12) and an oxidizer (14) supplied to said pilot stage means (16);
said igniter body means (40) also including a main combustion chamber (64) for producing said torch (104); and
said pilot flame (22) being used to ignite said pilot flame (22) in said main combustion chamber (64).

46. An apparatus as recited in claim 45, in which:
said fuel (12) and said oxidizer (14) are introduced into said pilot stage means (16) at a relatively low mass flow rate.

47. An apparatus as recited in claim 45, in which:
said fuel (12) and said oxidizer (14) are introduced into said main combustion stage (24) means at a relatively high mass flow rate.

48. An apparatus as recited in claim 45, further comprising the step of:
encouraging the ignition of said fuel (12) and said oxidizer (14) using a catalyst means (48) for promoting a chemical reaction.

49. An apparatus as recited in claim 45, further comprising the step of:
igniting said fuel (12) and said oxidizer (14) using an ignition source.
